(19) United States
(12) Patent Application Publication
(10) Pub. No.: US 2005/0222972 A1
(43) Pub. Date: Oct. 6, 2005

(54) Computer implemented, fast, approximate clustering based on sampling

(75) Inventors: Nina Mishra, San Ramon, CA (US); Daniel Anthony Oblinger, New York, NY (US); Leonard Pitt, Champaign, IL (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/140,857

(22) Filed: May 31, 2005

Related U.S. Application Data
(63) Continuation of application No. 10/039,617, filed on Jan. 4, 2002.

(51) Int. Cl. G06F 17/30; G06F 7/00

(52) U.S. Cl. 707/1

(57) ABSTRACT

(1) An approximate center-based clustering that utilizes sampling to cluster a set of n points to identify k>0 centers with quality assurance, but without the drawbacks of sample size and running time dependence on n. (2) An approximate conceptual clustering algorithm that utilizes sampling to identify k disjoint conjunctions with novel quality assurance, also without the drawbacks of sample size and running time dependence on n.

### BACKGROUND OF THE INVENTION

1. Field of the Invention

The present invention is directed toward the field of computer implemented clustering techniques, and more particularly, toward methods and apparatus for fast sampling based approximate clustering.

2. Art Background

In general, clustering is the problem of grouping objects into categories such that members of the category are similar in some interesting way. Literature in the field of clustering spans numerous application areas, including data mining, data compression, pattern recognition, and machine learning. The computational complexity of the clustering problem is very well understood. The general problem is known to be NP hard.

The analysis of the clustering problem in the prior art has largely focused on the accuracy of the clustering results. For example, there exist methods that compute a clustering with maximum diameter at most twice as large as the maximum diameter of the optimum clustering. Although such prior art clustering techniques generate close to optimum results, they are not tuned for implementation in a computer, particularly when the dataset for clustering is large. Essentially, most prior art clustering methods are not designed to work with massively large datasets, especially because most computer implemented clustering methods require multiple passes through the entire dataset which may overwhelm or bog down a computer system if the dataset is too large. As such, it may not be feasible to cluster large datasets, even given the recent developments in large computing power.

In order to try and overcome this problem, only a few prior art approaches have actually focused on some purported solutions. A few approaches are based on representing the dataset in a compressed fashion, based on how important a point is from a clustering perspective. For example, one prior art technique stores those points most important in main computer memory, compresses those that are less important, and discards the remaining points.

Another prior art technique for handling large datasets is through the use of sampling. For example, one technique illustrates how large a sample is needed to ensure that, with high probability, the sample contains at least a certain fraction of points from each cluster.

Attempts to use sampling to cluster large data bases typically require a sample whose size depends on the total number of points n. Such approaches are not readily adaptable to potentially infinite datasets (which are commonly encountered in data mining and other applications which may use large data sources like the web, click streams, phone records or transactional data). Essentially, all prior art clustering techniques are constrained by the sample size and running time parameters, both of which are dependent on n, and as such, they do not adequately address large data set environmental realities. Moreover, many prior art approaches do not make guarantees regarding the quality of the actual clustering rendered. Accordingly, it is desirable to develop a clustering technique with some guarantee of clustering quality that operates on massively large datasets for efficient implementation in a computer, all without the sample and time dependence on n.

### SUMMARY OF THE INVENTION

Fast sampling methods offers significant improvements in both the amount of points that may be clustered, and in the quality of the clusters which are produced. The first fast sampling-based method for center-based clustering, clusters a set of points, S, to identify k centers by utilizing probability and approximation techniques. The potentially infinite set of points, S, may be clustered through k-median approximate clustering. The second fast sampling-based method for conceptual clustering identifies k disjoint conjunctions that describe each cluster so that the clusters themselves are more than merely a collection of data points.

In center-based clustering, the diameter M of the space is determined as the largest distance between a pair of points in S. Where M is unknown, it may be accurately estimated by utilizing a sampling based method that is reflective of the aspects of the given space in the sample. Utilizing then, a determined value for M, a sample R of the set of points is determined, which in turn provides the input to be clustered, which in one embodiment, is according to α-approximation methods. Further provision is made for employing the above methodology in cases where there are more dimensions than there are data points, that the dimensions can be crushed in order to eliminate the dependence of the sample complexity on dimensional parameter d.

In conceptual clustering, in order to identify k disjoint conjunctions, each collection of k clusters is characterized by a signature s. A sample R from S is initially taken. Then, for each signature s, the sample R is partitioned into a collection of buckets where points in the same bucket agree on the literals as stipulated by the signature s. A cap on the number of allowable buckets exists so as not to unnecessarily burden computational complexity by dependence on n. For each bucket Bᵢ in the collection, a conjunction, tᵢ, reflecting the most specific conjunction satisfied by all examples in b, is computed, and an empirical frequency R(tᵢ) is computed, such that a quality may be defined as the sum over all buckets B₁, . . . , Bₖ induced by signature q of the product of conjunction length |tᵢ| and the empirical frequency R(tᵢ). These computational procedures yield respective quality numerical values from which the outputted clustering may be maximized.

### BRIEF DESCRIPTION OF THE DRAWINGS

FIG. 1 illustrates the “maximum diameter” between points for three exemplary clusters.

FIG. 2 is a flow diagram illustrating one embodiment for the fast sampling based clustering technique of the present invention within an exemplary context of a k-median clustering problem.

FIG. 3 is a flow diagram illustrating one embodiment for the fast sampling based clustering technique of the present invention, in an exemplary context of finding k disjoint conjunctions.

FIG. 4 is a block diagram illustrating an exemplary embodiment a typical computer system structure utilized in the fast sampling based clustering technique.

### DETAILED DESCRIPTION

Center-based Clustering:

For center-based clustering, clustering is a process to operate on a set “S”, of “n” points, and a number, “k”, to compute a partitioning of S into k groups such that some clustering metric is optimized. The number of points n to be clustered dominates the running time, particularly for prior art approximate clustering techniques which tend to be predicated on a time complexity of O (n²), which differs from the inventive approach as described below.

The application of clustering to knowledge discovery and data mining require a clustering technique with quality and performance guarantees that apply to large datasets. In many of the data mining applications mentioned above, the number of data items n is so large that it tends to dominate other parameters, hence the desire for methods that are not only polynomial, but in fact are sublinear in n. Due to these large datasets, even computer implemented clustering requires significant computer resources and can consume extensive time resources. As described fully below, the fast sampling technique of the present invention is sublinear, and as such, significantly improves the efficiency of computer resources, reduces time of execution, and ultimately provides for an accurate, fast technique for clustering which is independent of the size of the data set. Moreover, the inventive fast sample clustering has wide applicability over the realm of metric space, but will nevertheless be primarily discussed throughout in terms of one embodiment within Euclidean space, utilized within a computer implemented framework.

Overall, the fast sampling technique of the present invention provides the benefit of sampling without the prior art limitations according to sample size (potentially, an infinite size data set or an infinite probability distribution is clusterable according to the inventive methodology) and with the added benefit that the resulting clusters have good quality.

In general, the fast sampling technique of center based clustering reduces a large problem (i.e., clustering large datasets) to samples that are then clustered. This inventive application of applying sampling to clustering provides for the clustering to be sublinear so that there is no dependence on either the number of points n, or on time (which is typically a squared function of n.) Similar to the strategy employed in learning theory, the inventive fast sampling is, in one embodiment, modeled as “approximate clustering”, and provides for methods which access much less of an input data set, while affording desirable approximation guarantees. In particular, prior art methods for solving clustering problems also tend to share a common behavior in that they make multiple passes through the datasets, thereby rendering them poorly adapted to applications involving very large datasets. A prior art clustering approach may typically generate a clustering through some compressed representation (e.g., by calculating a straight given percentage on the points n in the dataset). By contrast, the inventive fast sampling technique of center based clustering applies an α approximation method to a sample of the input dataset whose size is independent of n, thereby reducing the actual accessing of the data set, while providing for an acceptable level of clustering cost that in fact yields a desirable approximation of the entire data set. Also, the reduced accessing of input data sets allows for manageable memory cycles when implemented within a computer framework, and can therefore render a previously unclusterable data set clusterable.

Furthermore, implicit in clustering is the concept of tightness. In defining the tightness, a family F:R^{d}→ [symbol] of cost functions exists where for each ƒ in F and for each x in R^{d}, ƒ(x) simply returns the distance dist from x to its closest center where dist is any distance metric on R^{d}. Reference may then be made to F as the family of k-median cost functions: F={ƒ_{cl, . . . ck}:ƒ_{cl, . . . ck}(x)=minᵢdist(x,cᵢ)}. Closely related, and also of interest, is the family of k-median² cost functions that return the squared distance from point to nearest center. This objective is the basis of the popular k-means clustering method. The inventive technique provides for the finding of the k-median cost function ƒ with minimum expected value. Because methods that minimize the sum of distances from points to centers also minimize the average distance from points to centers, a multitude of approximation methods may also be used. In the present embodiment, for a particular cost function ƒ in F, the expected tightness of ƒ relative to S, denoted E_{S}(ƒ) is simply the average distance from a point to its closest center, i.e.,

$${E}_{S} ( f ) = \frac{1}{n} {\sum }_{x ∈ S} {f}_{c1 , … , ck} ( x ) .$$

[In the event that S is a probability distribution over a finite space,

$${E}_{S} ( f ) = \frac{1}{n} {\sum }_{x ∈ S} {f}_{c1 , … , ck} ( x ) P {r}_{S} ( x ) .$$

In the event that S is an infinite-sized dataset, the summation in the expectation is replaced with integration in the usual way.] Define the optimum cost function for a set of points S to be the cost function ƒ_{S}εF with minimum tightness, i.e., ƒ_{S}=arg min_{ƒεF}E_{S}(ƒ). Similarly define the optimum cost function for a sample R of S to be the cost function ƒ_{R}εF with minimum tightness, i.e., ƒ_{R}=arg min_{ƒεF}E_{R}(ƒ). Because it is impossible to guarantee that the optimum cost function for any sample R of S performs like ƒ_{S} (such as in situations where an unrepresentative sample is drawn), the parameter δ indicates the closeness of the expected tightness values. Given that optimum clustering ƒ_{R} is NP-hard, and that α-approximation methods to ƒ_{R} represent very effective methods herein, α-approximation clustering to ƒ_{R} should then behave like ƒ_{S}. This establishes that F is α-approximately clusterable with additive cost ε iff for each ε,δ>0 there exists an m such that for a sample R of size m, the probability that E_{S}(ƒ_{R})≦αE_{S}(ƒ_{S})+ε is at least 1−δ. From this it is possible to derive the case where m does not depend on n under the Euclidean space assumption (and the case where m depends on log n under the more general metric space assumption).

In one embodiment, we consider the k-median clustering problem where given a set S of n points in R^{d}, the objective is to find k centers that minimize the average distance from any point in S to its nearest center. As shown in greater detail below, the fast sampling technique of the center-based clustering may take a sample

$$\tilde{O} ( {( \frac{{M}^{′} α d}{ɛ} )}^{2} k )$$

which suffices to find a roughly α-approximate clustering assuming a distance metric on space [0,M]^{d}. This and other techniques in the invention will generalize to other problems beside the k-median problem, but for purposes of illustrating the sublinear nature of the methods herein, the k-median problem is selected for illustrative purposes when demonstrating the independence of the sample size and running time on n.

While the inventive techniques may apply to a metric space (X, d), for the particular case of clustering in d-dimensional Euclidean space, it is possible to obtain time and sample bounds completely independent of the input dataset.

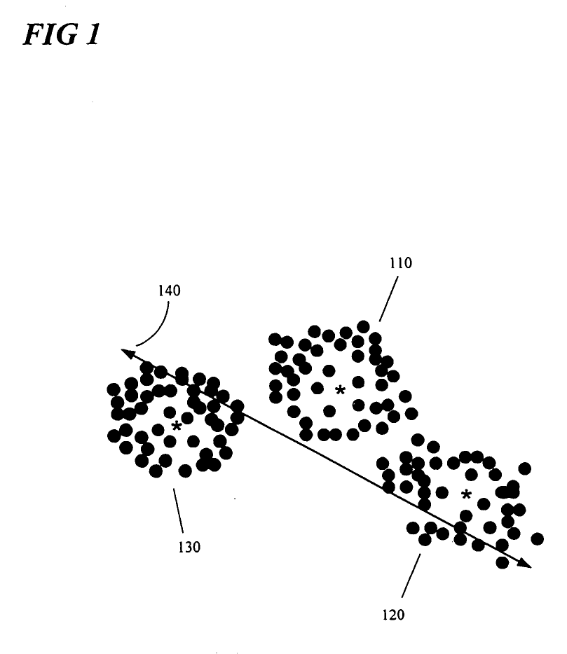

The fast sampling technique of the present invention will first determine diameter M, graphically depicted by the illustrative arrow 140 in FIG. 1, for a given cluster or center. The illustrative arrow 140 of FIG. 1 illustrates the diameter M, or the “maximum distance” between points for three exemplary clusters (e.g., clusters 110, 120 and 130). For this example, illustrative arrow 140 defines such a diameter M. The center based clustering of the present invention utilizes Min determining a sample size m₁.

After drawing a sample R of size m₁, k centers are discovered in R using standard clustering methods. The size mₗ of the sample R is chosen so that approximately good centers of R are approximately good centers of S. These approximately good centers for the sample R will, as further detailed hereafter, yield close to same result as if one had processed each and every point in S. The inventive center based clustering may therefore be seen—especially when taken within the context of the sample size mₗ given hereafter—as a minimization of the true average distance from points in S to the center(s) of respective clusters (referred to as “true cost”), despite the fact the center-based clustering approximately minimizes the sample average distance from points in R to the centers of their respective clusters (referred to as “sample cost”).

The objective of the k-median problem is to find a clustering of minimum cost, i e., minimum average distance from a point to its nearest center. As mentioned before, prior art k-median inquiries focus on obtaining constant factor approximations when finding the optimum k centers that minimize the average distance from any point in S to its nearest center. In doing so, these constant factor approximations are dependent on the time factor O(n²). By contrast, the inventive techniques provide for a large enough sample such that the true cost approximates the sample cost. Thus, minimizing the sample cost is like minimizing the true cost. In other embodiments, the fast sampling technique may use other clustering methods to achieve similar ends, such as other clustering methods which exist for the k-center problem. Accordingly, the fast sampling technique described herein may be applied to any clustering method that outputs k centers. These methods may output k centers that optimize a metric different from k center. Moreover, it is similarly important to note that any of the sample sizes referred to herein are exemplary in fashion, and one skilled in the art will readily recognize that any sample size may be utilized that ensures the uniform convergence property, i.e., that the sample cost approaches the true cost.

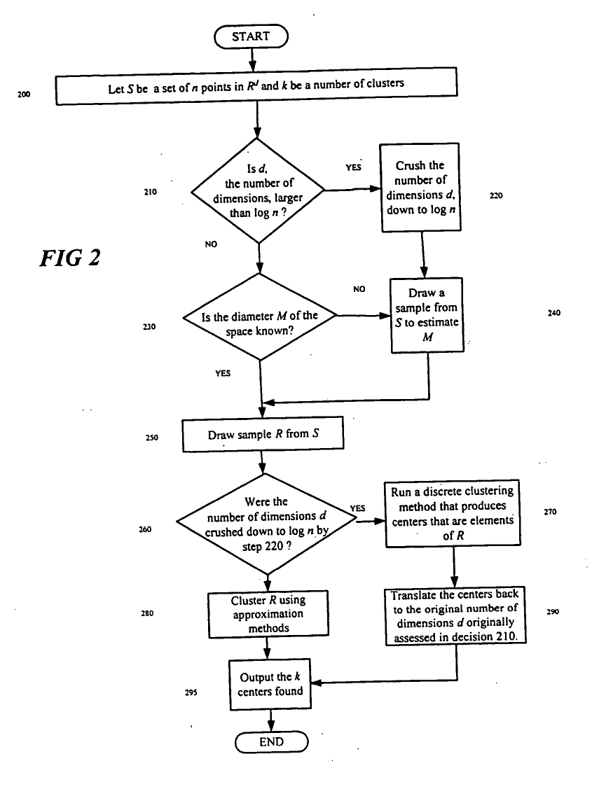

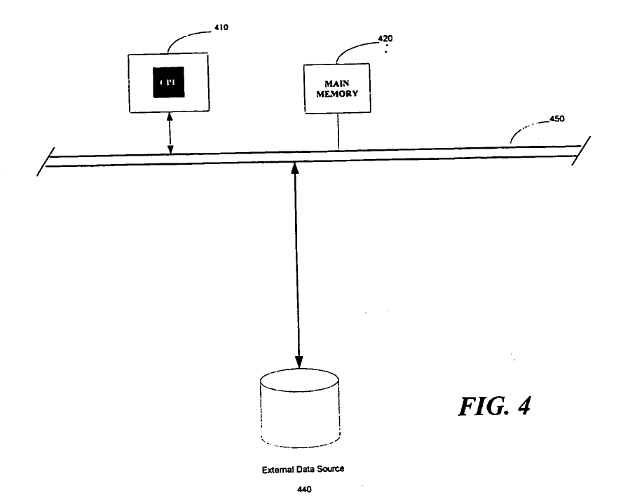

Turning then to FIG. 2, is a flow diagram illustrating one embodiment of the overall continuity of the fast sampling techniques, which may be implemented in a computer system such as that described hereafter in FIG. 4. An assessment is made as to whether the number of dimensions d is larger than log n (decision block 210, FIG. 2). If the number of dimensions d is in fact larger than log n, then d can first be crushed down to log n (as indicated at block 220), before proceeding to the next step.

An assessment is made at decision block 230, FIG. 2, to see if the diameter M of the restricted space R is known, and if not known, a sample is drawn as an estimate. More specifically, in certain practical situations, it may be known that points come from a space [0,M]^{d}, but in other situations, M may be unknown, or impractical to compute, if there are large datasets that would necessitate enormous scanning through a multitude of points. In such a situation (block 240, FIG. 2), sampling may be used to estimate M as M′, which can provide an approximately good clustering. The inventive technique, describes the drawing of a sample of size

$$\geq \frac{2 d}{ɛ} log \frac{2 d}{δ}$$

and compute M′ as the maximum distance between two points in a sample U, as graphically depicted in previously discussed FIG. 1. Specifically, the inventive sampling routine implies that the cost for the points in a space or cube [0,M]^{d} is at most ε and the cost for the points between the cube [0,M]^{d} and [0,M′]^{d} is at most εM. This relationship may be more directly expressed where S is defined as a set of points in the cube H=[0,M]^{d}, and where G is a subcube nested in H with the property that the number of points on any strip between G and H is at most

$$\frac{ɛ}{2 d} .$$

The probability that no point is drawn from any one of these strips is at most δ when a sample of size

$$\geq \frac{2 d}{ɛ} log \frac{2 d}{δ}$$

is drawn. The probability that a point in a particular strip between G and H is not drawn in m trials is at most

$${( 1 - \frac{ɛ}{2 d} )}^{m} .$$

This probability is at most

$$\frac{δ}{2 d} when m \geq \frac{2 d}{ɛ} log \frac{2 d}{δ} .$$

The probability that a point is not drawn in all 2d strips between G and H in m trials is at most δ by the sample size given. Hence, if a bound M on the space is unknown, then estimating M with M′ on a sample size given above, while running an α-approximation method on a sample size

$$\tilde{O} ( {( \frac{{M}^{′} α d}{ɛ} )}^{2} k )$$

yields an α-approximation clustering with additive cost ε(1+M).

A sample R is then drawn according to

$$\tilde{O} ( {( \frac{{M}^{′} α d}{ɛ} )}^{2} k ) ,$$

which suffices to find a roughly α-approximate clustering, assuming a Euclidean metric on [0,M]^{d}. As delineated at block 250, FIG. 2, this clustering is more specifically represented for the set S of points in [0,M]^{d} as having a sample R with size

$${m}_{1} \geq O ( {( \frac{M α }{ɛ} )}^{2} ( dk ln \frac{12 dM}{ɛ} + ln \frac{4}{δ} ) )$$

which provides for the clustering of a sample by an α-approximate k-median method that yields a k-median cost function ƒ_{R} such that with probability at least 1−δ, E_{S}(ƒ_{R})≦αE_{S}(ƒ_{S})+ε. For the general metric assumption, a sample of R of size

$$O ( {( \frac{α M}{ɛ} )}^{2} ( k ln n + ln \frac{4}{δ} ) )$$

provides the same k-median quality guarantee.

If the number of dimensions d were crushed down to log n in step 220, FIG. 2, then run a discrete clustering method, i.e., one that produces centers that are elements of R. Thereafter, translate the centers back to the original number of dimensions assessed in decision block 210, FIG. 2, before outputting (at block 295, FIG. 2), the k centers as determined by the clustering method employed in block 270, FIG. 2. However, if the number of dimensions d were not crushed down according to the inquiry at decision block 260, FIG. 23, then cluster R at block 280, FIG. 2, using any α-approximation methods as described above. Last, output the k centers as determined by the clustering method.

Conceptual Clustering Method:

In prior art applications, methods that output conclusions such as “this listing of 43 Mb of data point are in one cluster” may not be as useful as finding a description of a cluster. Conceptual clustering is the problem of clustering so as to find the more helpful conceptual descriptions. Within the context of an embodiment of a k disjoint conjunction example, the inventive techniques can not only offer a meaningful description of data, but also can provide a predictor of future data when clustering.

In practical applications, the set S of data to be clustered is typically a subcollection of a much larger, possibly infinite set, sampled from an unknown probability distribution. In contrast, the fast sampling techniques utilize processes similar to that of the probably approximately correct (“PAC”) model of learning, in that the error or clustering cost is distribution weighted, and a clustering method finds an approximately good clustering. Broadly speaking, the related mathematics are such that where D is an arbitrary probability distribution on X, the quality of a clustering depends simultaneously on all clusters in the clustering, and on the distribution, with the goal being to minimize (or maximize) some objective function Q( [symbol] t₁,t₂, . . . , tₖ [symbol] ,D) over all choices of k-tuples t₁, . . . , tₖ. In this way, PAC clustering can be utilized within a disjoint conjunction clustering application.

More specifically however, a d^{O(k}^{¹}⁾ method is provided for optimally PAC-clustering disjoint conjunctions over d Boolean variables. A k-clustering is k disjoint conjunctions. Let X={0,1}^{d} and let concepts be terms (e.g., conjunctions of literals), where each literal is one of the d Boolean variables {x₁,x₂, . . . x_{d}} or their negations. A k-clustering is a set of k disjoint conjunctions {t₁, . . . tₖ}, where no two tᵢs are satisfied by any one assignment. A quality function is then defined as:

$$Q ( 〈 {t}_{1 ,} {t}_{2 ,} … , {t}_{k} 〉 , D ) = {\sum }_{i = 1}^{k} \vert {t}_{i} \vert {Pr}_{D} ( {t}_{i} )$$

where Pr_{D}(tᵢ) is the fraction of the distribution (also termed “probability”) that satisfies tᵢ. It is evident that an optimum k-clustering is always at least as good as an optimum k−1 clustering, since any cluster can be split into two by constraining some variable, obtaining two tighter clusters with the same cumulative distributional weight. Hence, the number of desired clusters k is assumed to be input to the method. Further, it is required that the conjunctive clusters cover most of the points in S (or most of the probability distribution). This requirement is enforced with a parameter γ that stipulates that all but γ of the distribution must be covered by the conjunctions. Thus, the objective is to maximize the length of the cluster descriptions (i.e., longer, more specific conjunctions are more “tight”), weighted by the probabilities of the clusters, subject to the constraint that all but a γ fraction of the points are satisfied by the conjunctions (alternatively, at least 1−γ of the probability distribution is covered).

Conceptual clustering provides clusters that are more than a mere collection of data points. Essentially, the inventive conceptual clustering outputs the set of attributes that compelled the data to be clustered together.

TABLE 1
Example of Customer Purchase Behavior

| | Printer (P) | Toner cartridge (T) | Computer (C) |
|---|---|---|---|
| cust 1 | 1 | 1 | 0 |
| cust 2 | 1 | 1 | 1 |
| cust 3 | 1 | 0 | 1 |
| cust 4 | 0 | 0 | 1 |

By way of graphic depiction of this concept, Table 1 shows an example of four customers together with the items they purchased. In the table, customer 1 purchased a printer and a toner cartridge, but did not purchase a computer. Assuming an exemplary clustering of k=2, Table 1 can be broken into two clusters, one including customers 1 and 2 and the other including customers 3 and 4. In determining the aforementioned quality, we measure a length of a conjunction (a grouping of attributes in a string of positions, also termed a “data length”) by the number of variables or attributes making up the respective conjunction, while a probability of a conjunction is determined from the number of points (in this example the number of customers) that satisfy the conjunction.

The longer a conjunction, the fewer the number of points that satisfy it. For example, a short conjunction P (represented by customers who bought Printers) includes the first three customers. On the other hand, the longer conjunction P [symbol] T, i.e., those customers that bought both printers and toner cartridges, is satisfied by only the first two customers.

Utilizing the above described quality function max

$${\sum }_{i = 1}^{k} \vert {t}_{i} \vert Pr ( {t}_{i} ) ,$$

for the two conjunctions P and C we see that these short conjunctions have quality that yield:

$$\vert P \vert Pr ( P ) + \vert C \vert Pr ( C ) = 1 \times \frac{3}{4} + 1 \times \frac{3}{4} ,$$

which equals 1.5 (where the data length of P is 1, and the data length of C is 1, and the probability of each is three out of four data points

$$( \frac{3}{4} )$$

being satisfied). Similarly, we may use the same quality function for the two conjunctive clusters P [symbol] T and \overline{T} [symbol] C to obtain:

$$\vert P ⋀ T \vert Pr ( P ⋀ T ) + \vert \overline{T} ⋀ C \vert Pr ( \overline{T} ⋀ C ) = 2 \times \frac{2}{4} + 2 \times \frac{2}{4} ,$$

which equals 2. This means that the conjunctions P [symbol] T (represented by the first two customers) and \overline{T} [symbol] C (represented by customers 3 and 4), have a better quality (e.g., 2), than P (represented by the first 3 customers) and C (represented by the last 3 customers), which only have a quality of 1.5.

In the k disjoint conjunction problem, such kinds of clustering produce disjoint clusters, where a variable is negated in one cluster, and un-negated in another cluster. For example, two arbitrary clusters designated as say, P [symbol] T together with T [symbol] C are not disjoint because there are points that satisfy both of these conjunctions (customer 2). Similarly, conjunctive clusters where the variables do not overlap may not be disjoint, like P and C, since customers 2 and 3 satisfy both conjunctions. By contrast, a cluster of say, P [symbol] T and \overline{T} [symbol] C would be disjoint.

In one exemplary embodiment known as the k disjoint conjunction problem, the disjoint aspect of clusters can be utilized to provide an inventive signature q between clusters. Each set of k disjoint conjunctions has a corresponding signature q that contains a variable that witnesses the difference between each pair of conjunctions. The length of a signature is thus O(k²). The following table gives a simple example of three signatures for k=2 clustering of the data in Table 1.

TABLE 2
Example Signature and induced disjoint clusters for k = 2 clusters.

| Signature | Skeleton | Partition of Points | k disjoint conjunctions |
|---|---|---|---|
| P | P, \overline{P} | {110, 111, 101}, {001} | P, \overline{P} [symbol] \overline{T} [symbol] C |
| \overline{T} | \overline{T}, T | {101, 001}, {110, 111} | \overline{T} [symbol] C, P [symbol] T |
| C | C, \overline{C} | {110}, {111, 101, 001} | P [symbol] T [symbol] \overline{C}, P [symbol] C |

The first signature “P” means that the first conjunction contains the literal P and the second conjunction contains the literal \overline{P}. Thus the second column shows the induced skeleton for this signature. The third column indicates the buckets into which the points are partitioned. The points “110,111,101” are associated with the first bucket since the first bit position (corresponding to P) is always “1”. The point “001” is placed in the second bucket since this point satisfies \overline{P}. Given the buckets, a most specific conjunction is computed. The most specific conjunction is a conjunction of attributes that is satisfied by all the points and yet is as long as possible. For the first bucket, the conjunction P is as long as possible since adding any other literal (T,\overline{T},C, or \overline{C}) will cause one of the points to not satisfy the conjunction. For the second bucket, the conjunction \overline{P} can be extended to include \overline{T} [symbol] C and the resulting conjunction covers exactly “001” and can't be extended further.

In general, the signature q of k disjoint conjunctions may be defined as a k-signature having a sequence [symbol] lᵢⱼ [symbol] l≦i≦j≦k where each lᵢⱼ is a literal in {xᵢ, . . . , x_{d},\overline{x}₁, . . . , \overline{x}_{d}}. Associated with each k-signature is a “skeleton” of k disjoint conjunctions s₁, . . . , sₖ, where conjunction sᵢ contains exactly those literal lᵢⱼ for i<j, and the complements of the literals lₖᵢ for k<i. k disjoint conjunctions tᵢ, . . . tₖ are a specialization of a skeleton s₁, . . . sₖ iff for each i, the set of literals in sᵢ is contained in the set of literals in tᵢ. Clearly, if q is a k-signature, then the skeleton conjunctions induced by q are disjoint, as are any k conjunctions that are a specialization of that skeleton. Furthermore, every k disjoint conjunctions are a specialization of some skeleton induced by a k-signature.

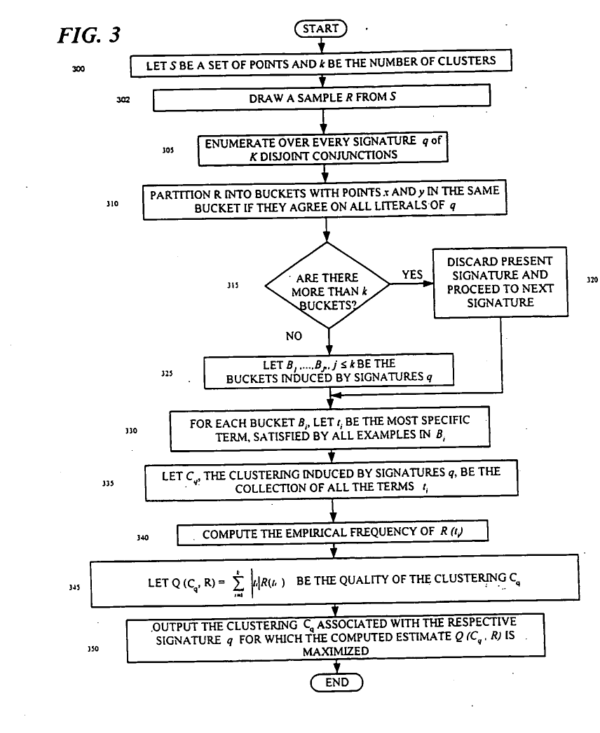

According to the signature q, the sample R may then be partitioned into buckets B according to the literals in the signature. For each bucket b in B, we can then compute the most specific conjunctive description. The overall method for identifying k disjoint conjunctions may then be exemplified as in the flow diagram FIG. 3, which illustrates one embodiment for the conceptual clustering technique of the present invention.

A sample R is drawn at block 300, FIG. 3. In block 305, FIG. 3, the method enumerates over all d^{O(k}^{²}⁾ signatures of k disjoint disjunctions. Sample R is then partitioned into buckets with points x and y in the same bucket iff they agree on all literals of signature q (block 310, FIG. 3). If it is determined at decision block 315, FIG. 3, that there are more than k buckets, then the present signature q will be discarded at block 320, FIG. 3, and progression will be made to the next signature s. If, however, there are not more than k buckets, then progression will be made to block 325, FIG. 3, where B₁, . . . , Bⱼ, j≦k will be the buckets B induced by signature q. For each bucket B, tᵢ will be the most specific conjunction satisfied by all examples in B (block 330, FIG. 3). For each bucket B, C_{q} will be the clustering induced by signature q, and will signify the collection of disjoint conjunctions tᵢ (block 335, FIG. 3). R(tᵢ), the empirical frequency of the term tᵢ, will then be computed for each term tᵢ (block 340, FIG. 3). The (estimated value of) quality Q will then be defined according to the quality equation previously discussed:

$$Q ( {C}_{q} , R ) = {\sum }_{i = 1 , … , k} \vert {t}_{i} \vert R ( {t}_{i} )$$

(block 345, FIG. 3). The clustering C_{q} associated with the signature q for which the computed estimate Q(C_{q},R) is maximized, is outputted (block 350, FIG. 3).

In one embodiment, the size of the sample R drawn in Block 300, FIG. 3, is large enough to ensure that the empirical frequency of each term tᵢ, denoted R(tᵢ) approaches the true frequency. In this embodiment, if the sample size is

$${m}_{2} \geq min \{ \frac{1}{γ} ( dk ln 3 + ln \frac{2}{δ} ) , \frac{2 {d}^{2} {k}^{2}}{{ɛ}^{2}} ( d ln 3 + ln \frac{2}{δ} ) \} ,$$

then with probability at least 1−δ, the clustering found by the method covers all but γ of the distribution, and the quality of the clustering is within an additive value ε of the optimum clustering.
Computer Implementation Efficiency:

Clustering of large data sets, as it relates to the use of computer resources, may generally consume enormous amounts of memory and processing bandwidth. If mem is the size of memory in the computer, then one issue to maximize the computer implementation of clustering is to ascertain the best way to cluster S, using any clustering technique, when |S|>>mem.

In general, most computer implemented clustering methods require multiple passes through the entire dataset. Thus, if the dataset is too large to fit in the main memory of a computer, then the computer must repeatedly swap the dataset in and out of main memory (i.e., the computer must repeatedly access an external data source, such as a hard disk drive). In general, a method that manages placement or movement of data is called an external memory method (i.e., also referred to as I/O efficiency and out-of-core method). The I/O efficiency of an external memory method is measured by the number of I/O accesses it performs. Also, I/O efficiency of an external memory method is measured by the number of times the input dataset is scanned. In the inventive technique, however, the number of scans is greatly reduced by the sampling approach described previously. Moreover, the prior art computer based clustering was incapable of processing vast data sets, particularly where the amount of data was infinite or approached infinity, unlike the inventive sampling which overcomes this limit.

By way of an exemplary embodiment, FIG. 4 is a block diagram illustrating one embodiment for implementing the fast sampling technique in a computer system. As shown in FIG. 4, the computer includes a central processing unit (“CPU”) 410, main memory 420, and an external data source 440, such as a hard drive. In general, the fast sampling technique is implemented with a plurality of software instructions. The CPU 410 executes the software instructions according to the previously described techniques in order to identify the clusters. As described above, the fast sampling technique has application for processing massively large datasets. Initially, the datasets may reside in a persistent data store, such as external data source 440. As shown in FIG. 4, data from the data set S is transferred on a bus 450. The bus 450 couples main memory 420 and external data source 440 to CPU 410. Although FIG. 4 illustrates a single bus to transport data, one or more busses may be used to transport data among the CPU 410, main memory 420 and external data source 440 without deviating from the spirit and scope of the invention.

To process a massively large dataset using a prior art clustering technique, the program either swaps data in and out of main memory 420 and/or the program executes numerous input/output operations to the external data source 440. The fast sampling method of the present invention improves I/O efficiency because a very large dataset, initially stored in the persistent data store 440, is sampled and stored in main memory 420. The clustering method calculation may be executed on these vast data sets without any data swapping to the external data source 440, unlike the prior art clustering techniques which would bog down or simply overwhelm all aspects of the computer system when infinite or near infinite data sets are processed. Furthermore, the fast sampling technique requires only one scan of the dataset, whereas the prior art clustering techniques require multiple scans of the dataset. Hence, the descried computer implementation provides for a more efficient method that is capable of clustering infinite and near infinite data sets, all while affording the aforementioned quality guarantees.

Although the present invention has been described in terms of specific exemplary embodiments, it will be appreciated that various modifications and alterations might be made by those skilled in the art without departing from the spirit and scope of the invention.

1-10. (canceled)

11. A method of software execution for center-based clustering, comprising:
calculating a representational value of a diameter (M) of a space that comprises a set (S) of points (n) in a dataset;
calculating a sample (R) from said set (S) of said points (n);
calculating plural clusters from said sample (R); and
calculating plural cluster centers (k) as identified by said plural clusters of said sample (R) such that the plural cluster centers (k) for the sample (R) represent cluster centers for the set (S).

12. The method of claim 11, wherein a cluster in the plural cluster centers (k) minimizes an average distance from a point in set (S) to a nearest center.

13. The method of claim 11, wherein calculating the plural cluster centers (k) is independent of a size of the dataset.

14. The method of claim 11, wherein calculating the plural cluster centers (k) is independent of execution time of processing the points (n).

15. The method of claim 11 further comprising, reducing a number of dimensions (d) to log n if d is larger than log n.

16. The method of claim 11 further comprising, if the diameter (M) is unknown, then calculating a sample of size greater than or equal to (2d/ε) log (2d/δ), where d is a number of dimensions.

17. The method of claim 11, wherein the diameter (M) represents a maximum distance between points in the sample (R).

18. A computer system, comprising:
a memory for storing software instructions;
a data source for storing a dataset; and
a processor executing the software instructions to:
calculate a diameter of a space that includes a set of points in the dataset;
calculate a sample from said set of said points;
calculate plural clusters from said sample; and
calculate plural cluster centers for said sample such that the cluster centers for the sample represent cluster centers for the set.

19. The computer system of claim 18, wherein the processor executes the software instructions further to:
calculate a discrete clustering of the sample in a reduced space;
translate the plural cluster centers back to an original space prior to outputting the plural cluster centers.

20. The computer system of claim 18, wherein the data source is external to the computer system, and the plural cluster centers are calculated without data swapping with the data source.

21. The computer system of claim 18, wherein the plural cluster centers are calculated with a single scan of the dataset.

22. A method of software execution for center-based clustering, comprising:
determining a diameter of a space that includes a set of points in a dataset;
determining a sample from said set of said points, wherein said sample is a subset of said set;
determining plural clusters from said sample; and
determining plural cluster centers for said plural clusters of said sample such that the plural cluster centers for the sample represent cluster centers for the set.

23. The method of claim 22 further comprising, determining said plural cluster centers for said plural clusters with a single scan of the dataset.

24. The method of claim 22, wherein the diameter of the space is a largest distance between a pair of points in said set.

25. The method of claim 22 further comprising, estimating the diameter of the space by utilizing a sampling based method on the sample.

26. The method of claim 22 further comprising, reducing said set to the sample that has a size independent of a number of said points in order to reduce actual accessing of the dataset.
